(19) United States
(12) Patent Application Publication
(10) Pub. No.: US 2012/0221375 A1
(43) Pub. Date: Aug. 30, 2012

(54) METHOD AND APPARATUS FOR SMART SAFETY MANAGEMENT

(75) Inventor: Daniel Howard TILLOTSON, Washington Crossing, PA (US)

(73) Assignee: ARINC INCORPORATED, Annapolis, MD (US)

(21) Appl. No.: 13/405,853

(22) Filed: Feb. 27, 2012

Related U.S. Application Data
(60) Provisional application No. 61/447,665, filed on Feb. 28, 2011.

(51) Int. Cl. G06Q 10/00

(52) U.S. Cl. 705/7.28; 705/325

(57) ABSTRACT

A method and apparatus for smart safety management is disclosed. The method may include receiving a request from a user to complete risk assessment form, retrieving a risk factors database from a memory and providing the risk factors database to the user, receiving risk factor information from the user concerning items in the risk factor database and any new or changed in risk factor information as defined by the user, storing the new or changed risk factor information received from the user in the risk factors database, calculating risk factor values based on the received risk factor information from the user concerning items in the risk factor database and any new or changed risk factor information as defined by the user, and outputting the risk assessment form containing the calculated risk factor values and providing the form to the user.

### BACKGROUND OF THE DISCLOSED EMBODIMENTS

1. Field of the Disclosed Embodiments

The disclosed embodiments relate to aircraft flight safety management.

2. Introduction

Per FAA Advisory Circular 120-92, a Safety Management System (SMS) is essentially a quality management approach to controlling risk. It also provides the organizational framework to support a sound safety culture. For general aviation operators, an SMS can form the core of the company's safety efforts. For certificated operators such as airlines, air taxi operators, and aviation training organizations, the SMS can also serve as an efficient means of interfacing with FAA certificate oversight offices. The SMS provides the company's management with a detailed roadmap for monitoring safety related processes.

An integral and key part of SMS is Safety Risk Management. This requires a formal system of hazard identification and defines a process used to assess, evaluate, and mitigate identified risks. A central facility may be supporting the Risk Management portion of their customers' SMS.

International Civil Aviation Organization (ICAO) has defined a four component/twelve element SMS framework for worldwide utilization, and has incorporated the requirements into their Standards and Recommended Practices (SARPs). Annex 6, entitled Operation of Aircraft, was amended to require operators to develop and comply with an SMS. Although ICAO is recognized as an international standards body and the SARPs contain technical and operational requirements, it has no regulatory authority. Regulatory authority remains within the purview of individual States.

If an operator conducts flights exclusively in their State of registry, the ICAO SARPs do not apply. However, once an operator leaves their State of registry, they become bound by the ICAO SARPs and the requirements of the States' in which they operate or overfly. Because of this, there is currently a mix of requirements for operators to have an SMS.

### SUMMARY OF THE DISCLOSED EMBODIMENTS

A method and apparatus for smart safety management is disclosed. The method may include receiving a request from a user to complete risk assessment form, retrieving a risk factors database from a memory and providing the risk factors database to the user, receiving risk factor information from the user concerning items in the risk factor database and any new or changed in risk factor information as defined by the user, storing the new or changed risk factor information received from the user in the risk factors database, calculating risk factor values based on the received risk factor information from the user concerning items in the risk factor database and any new or changed risk factor information as defined by the user, and outputting the risk assessment form containing the calculated risk factor values and providing the form to the user.

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 is an exemplary diagram of a smart safety management environment in accordance with a possible embodiment of the disclosure;

FIG. 2 is a block diagram of an exemplary smart safety management unit in accordance with a possible embodiment of the disclosure; and

FIG. 3 is an exemplary flowchart of a smart safety management process in accordance with one possible embodiment of the disclosure.

### DESCRIPTION OF THE DISCLOSED EMBODIMENTS

Additional features and advantages of the disclosed embodiments may be set forth in the description which follows, and in part may be obvious from the description, or may be learned by practice of the disclosed embodiments. The features and advantages of the disclosed embodiments may be realized and obtained by means of the instruments and combinations particularly pointed out in the appended claims. These and other features of the present disclosed embodiments may become more fully apparent from the following description and appended claims, or may be learned by the practice of the disclosed embodiments as set forth herein.

Various embodiments of the disclosed embodiments may be discussed in detail below. While specific implementations may be discussed, it should be understood that this be may be done for illustration purposes only. A person skilled in the relevant art may recognize that other components and configurations may be used without parting from the spirit and scope of the disclosed embodiments.

The disclosed embodiments comprise a variety of embodiments, such as a method and apparatus and other embodiments that relate to the basic concepts of the disclosed embodiments. Note that while this disclosure discusses aircraft, airline and travel-related uses for the disclosed embodiments, the disclosed embodiments by no means limited to that area and may be applied to a wide variety of environment and uses.

The proposed disclosed system and method concerns a method and apparatus for smart safety management. The disclosed embodiments may provide tools, integrated with flight planning and weather functions, to assist customers in completing the Risk Assessment portion of the SMS. At a high level, the disclosed embodiments may:
1. Provide a library of risk factors that can be used by customers to define/build their Risk Assessment form. Customers may be able to define the criteria to be used in assigning risk factors to each item
2. Provide a means for customers to define new risk factors to support their operations and SMS requirements, and then add these to the library for use by other customers.
3. Use the information defined above to create a form that is available on a web site that customers may use to formally evaluate the risk for individual flights. Wherever possible, an assessment of the risk for each individual item may be made using the criteria defined by the customer. Customers may be able to modify any of the system derived values.
4. Provide means for printing and distributing the completed form.
5. Retain user-entered information for some period of time to support the Safety Assurance and Safety Promotion component of the SMS.

The disclosed embodiments may provide a way for Customers to store customer-generated documents containing SMS-related information such as Emergency Contact and accident/incident notification procedures. This customer-provided (and maintained) information would be visible to users and Flight Commanders (FCs).

The disclosed embodiments may also involve evaluating risk factors that may be custom generated, for example:

1. Company administrators (Admins) may be responsible for defining risk factors, criteria, and risk level associated with each risk factor. They may also be provided with a means for uploading documents that may be made available to users and FCs. They may be provided with the tools to accomplish this via their administrator login.
a. Provide an SMS Subtab under the My Company tab to keep the SMS-related activities separate from other functions. Other locations may be used, but the set up should be kept on its own.
b. Provide a library of risk factors for use by the Admins. Admins can use as many of the central facility-stored risk factors as they want to create their Risk Assessment Form. Library risk factors would not be modifiable by Admins. Library would be sorted by categories defined by the disclosed embodiments that may include:
   Trip Type
   Airport
   Duty Day/Flight Hours
   Aircraft Loading
   Time of Day
   Crew Experience/Currency
   Environmental/Weather
   External Factors
   Terrain
   Runway Conditions
c. Provide a means for Admins to define and store Risk Factors that are not in the Library. Once stored by an Admin, these Risk Factors could be added to the Library for use by other customers.
d. Provide a field for the Admins to enter a comment for each Risk Factor included in their form and show this comment field as part of the form generated on the web site. If no comment is entered by the Admin, the comment section of the generated form may be blank. The user completing the form may be able to add comments to this field during their completion of the form, but they may not be able to overwrite or delete the Admin-entered comment(s).

2. Provide a means for Admins to assign criteria for each Risk Factor and a default risk level for each criteria. For example, if an Admin elects to include a Risk Factor for Runway Length, he would be able to set the criteria to runway shorter than 4000 feet and assign a risk level of 3 for this condition. This information may be used as defined in the User Account Requirements section below.

3. Provide a means for the Admin to determine which users have SMS rights.

4. Modify the User Page so that total hours, hours in type, recent hours (last 90 days) can be entered. A means of using information from customers scheduling system may be provided in addition to allowing entry by the Admin to provide this information.

5. Provide a means for Admin to define levels where risk mitigation is required, and whether this is done on individual risk factors or on the sum of risk factors. An option may also be provided for an Admin to select if mitigation is required based on the sum of risks for one or more Risk Categories.

6. Provide a means for the Admin entered information for a customer's aircraft to be copied to other aircraft in the Admin's account. The risk factor information may be stored and associated with one or more customer aircraft.

7. Provide a means for the Admin to modify any previously entered information, or to add/delete risk factors. Logging of these changes should be a part of the process.

8. Provide a means for the Admin to define any elements to be included at the end of a computed flight plan, i.e., a summary of particular risks or risk items. This may use functionality similar to adding a Coded Departure Routes (CDR) summary, etc. at the bottom of a computed flight plan.

9. Provide a means for the Admin to upload documents with SMS-related information. The Admin would be responsible for generating, uploading, and maintaining current information in the uploaded documents. Similar functionality already exists for the International Trip Planning Database known as TIPSY. The following information may be required with each uploaded document.
a. Document Tide selectable from drop down (specifics to be defined)
b. Editable Document Expiration Date
c. Select Assignee of the document from Drop Down (e.g. tails of the account)
d. Upload Capability for one file

Limits on file size, file type, and number of files that can be uploaded may be imposed. The Expiration Date may be used to notify the Admin that a review of the document(s) is needed.

10. Provide a means for the Admin to upload completed Risk Assessment form. These forms may be retained for 12 months, may be maintained separately from the uploaded documentation shown in the previous requirement, and may be assessable to Admins for analysis purposes that may be defined in their SMS.

The following are User Account Requirements:

1. Individual users with Flight Planning rights may have a place on the web site where the form generated by the Admin's actions above can be viewed, modified, printed, and distributed. The user may be provided with the ability to display and print a blank. Risk Assessment form so that the entire Risk Assessment process can be completed manually by the crew. In some web site designs, a new SMS Subtab may be added to the Flight Planning tab.
a. This form would contain the risk factors, criteria, and risk levels using the Admin-entered information.
b. Any entered data can be modified by the user.
c. Last data entered in the form is retained throughout the user session. Data are saved when user prints the form, sends the form, logs out, or the session times out. A user may be able to leave/return to the form multiple times during a session without data being lost.
d. A means for the user to retrieve previously completed form(s) after a session is closed may be needed so that the risk assessment can be updated as additional/updated information becomes available to the user. This may result in a requirement to have means for the user to save a completed form before it becomes associated with a flight plan (see item 5 below in this section).

2. Risk assessments may be made at a central facility and values populated on the form using the criterion defined by the Admin. The following information may be used to complete the risk assessment.
a. Parsing of Meteorological Terminal Aviation Routine Weather Reports (METARs) to determine current meteorological conditions affecting the departure airport. This may include ceiling, visibility, restrictions to visibility (snow, rain, thunderstorms), wind, and temperature. Some functionality may exist in support of Performance computations.
b. Parsing of Terminal Area Forecast reports (TAFs) to determine forecast conditions affecting the departure and destination airport. This may include ceiling, visibility, restrictions to visibility (snow, rain, thunderstorms), and wind. Forecast temperatures may need to be obtained from some source other than a TAF.
c. Parsing of Notice to Airmen reports (NOTAMs) to determine current airport conditions and would include items such as airport closure, runway closures, runway length restrictions, runway conditions (snow, packed ice, etc), approach lighting system outages, approach availability, and braking action reports.
d. Information on all runways at an airport (runway length, runway width, runway lighting, etc).
e. Indication in an Airports database regarding whether an airport is controlled or uncontrolled and the operating hours of the tower.
f. Information in the Airports database regarding the approaches (precision/non-precision) available to each runway end.
g. Parsing of Pilot Reports (PIREPs) to obtain information on wind shear, turbulence, runway conditions, and braking action.
h. Use of geospatial definition of mountainous terrain areas, oceanic areas, and other areas with high risk operation (e.g., polar or remote areas). This information is needed because of the increased risk in operating in these areas.
i. Sunset/sunrise definitions for airports.
j. Crosswind component and tailwind component.
k. Parsing takeoff and landing limit weights.
l. Identifying Pilot in Command (PIC) Second in Command (SIC) (individuals) and their experience and currency in the aircraft.
m. Extracting Fuel on Board (FOB) at landing from computed flight plans.
n. Using information from Terminal Weather Information for Pilot (TWIP)-capable airports to assess risk related to convective activity. p 3. All weather related assessments may need to provide the time stamp for the METAR or TAF period used. The time a PIREP was made may be needed and the valid time period for NOTAMs.

4. Provide a means (text box) for users to document how individual and cumulative risks were mitigated to the point where the flight could be operated.

5. Provide tracking information for each form to include (as a minimum) PIC, SIC, Date of Flight, Departure/Destination city pair, estimated time of departure (ETD), and flight plan recall number. Each form may be associated with a recall number.

6. Provide a means of allowing the Risk Assessment form to be completed for Quick File flight plans in addition to the process defined above for flight plans generated using the Create Flight Plan page.

Outputs: Customers may have the ability to print or transmit the Risk Assessment form via the following means.

a. Print from the SMS Subtab

b. Fax or email the Risk Assessment form, including risk mitigation text, from the SMS Subtab

c. Include the Risk Assessment form with a computed flight plan. Distribution of the computed flight plan is via existing functionality.

d. Include in a Fax Package when the associated flight plan recall number is included in the package.

e. Include a summary of risk items, as defined by the Admin, at the end of a computed flight plan.

f. Retrieve a previously completed and stored risk assessment form and complete items a-c of this section for that form.

Individual users with SMS rights granted by the Admin may be able to view the SMS-related documents uploaded by the Admin.

The following may be FC Account Requirements:

1. FC's may be inhibited from making any changes to Risk Assessment forms unless logged in as a user. All changes made to previously computed form may need to be logged along with the user/FC making the change.

2. Regular FC's logged into User accounts.

a. May need to define and document procedures for FC obtaining information from users over the phone to complete Risk Assessment form.

b. Logging of who is entering data is required.

c. May be able to view SMS-related documents uploaded by the Admin

3. Super FC's may be provided with the following capabilities.

a. Manage the risk factor library

b. Add new risk factor categories or move individual risk factors to different categories.

c. Add new risk factors

d. Add new risk assessment scales

e. On rare occasions, set up risk assessment form for computer challenged Admins.

Other General Requirements

1. Risk assessment forms may be tied to individual flight plans for now and all risk assessments made for individual flights. User may need to evaluate a group of flight plans to assign a risk level for risk factors that may be defined for a multi-day, multi-leg trip.

2. Completed risk assessment forms may be stored for some period of time. These may be used to support the analysis, evaluation, modification requirements of SMS.

3. Design should support ability to use an API to obtain data that presently exists in conventional scheduling systems. This information could include data on pilot experience and currency, trip details (number of legs, rest period, expected duty day), and others.

4. SMS functionality may not be made available on the Mobile site.

5. Transactions may be provided whenever a Risk Assessment form is completed. An SMS transaction is needed when a flight plan recall number is assigned and when a flight plan is either recomputed or replanned.

6. The Risk Factor assessment may be updated each time a flight plan is recomputed or replanned. When a flight plan is replanned and the recall number is retained, the previously generated risk assessment form may be overwritten and an updated assessment may be associated with the flight plan recall number. There may also be a requirement for a user to be able to ‘manually’ force an update of a previously stored risk assessment form at any time.

7. When a value is assigned to a customer's risk factor by a central facility (using the criteria defined by the company Admin), the data used for making the assessment may be shown on the form so that the user can (1) confirm the proper assessment has been made and (2) to show the user the basis for the assigned risk level. For example, if a company Admin has established a risk factor of 3 for a crosswind component greater than 15 knots, the computed crosswind component may be shown in the form (on the web site and in the printed form), along with the selected runway and the wind parsed from the METAR.

8. The users' ability to modify the Risk Assessment form may be inhibited at ETD+2 hours. The ETD may be the latest filed departure time. A user may still be able to print or otherwise distribute the form after this time and modifications can be made on that copy by the user, but no changes to the electronic form (including the central facility's automatic assessments) may be possible after this time.

9. The company Admin may be provided with a means for modifying a previously completed form to record last minute changes made by the crew, or to record changes made by the crew after the form was last updated on the web site. To ensure the integrity of the automatic assessments made prior to the flight, any changes made may require the Admin to enter a reason for the change before the previously saved form can be updated with the new information. The original risk value/assessment may be retained so that the original and revised risk level is shown on the form.

10. The Risk Assessment form may include a distinctive indication of the risk factors that a central facility can automatically determine. This indication may be distinctive on both the web site and when the form is printed. This may be required to ensure that a user does not assume that because a risk factor has no value associated with it that the central facility determined that there was no risk for that flight.

11. A way for a user to define the runway to be used at both the departure and destination airport may be needed. For tails that are weight and balance enabled, the selected runway may be used from the Performance section of the Create Flight Plan page. However, something for aircraft that are not weight and balance enabled may be needed and for users that do not compute weight and balance. The most logical place for this entry would be on the Create Flight Plan page.

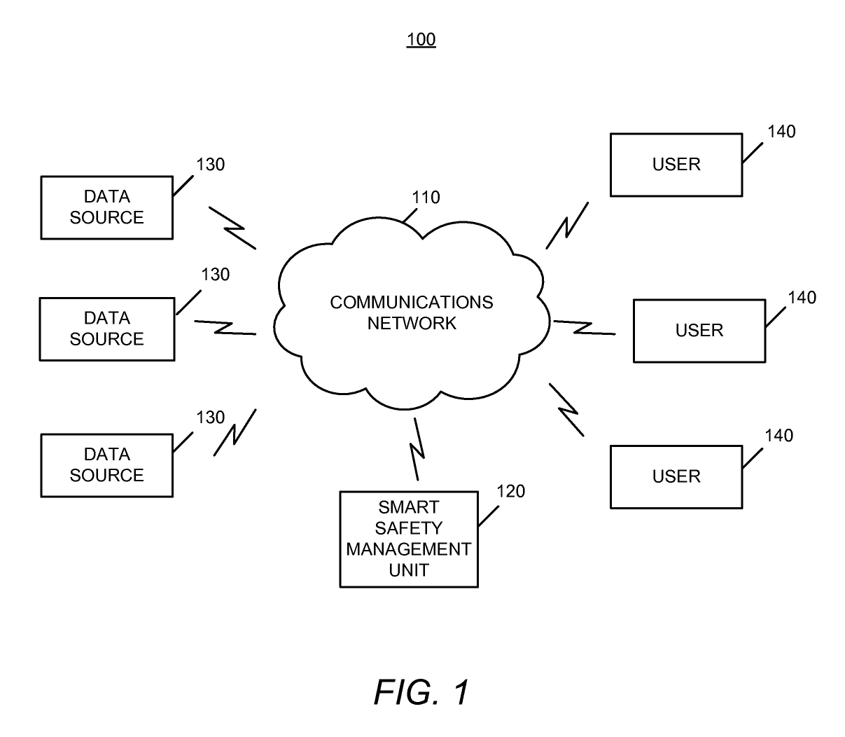

FIG. 1 is an exemplary diagram of a smart safety management environment 100 in accordance with a possible embodiment of the disclosure. The smart safety management environment 100 may include a smart safety management unit 120, one or more data sources 130, one or more users 140, all connected through communications network 110. Note that although the connections in FIG. 1 are shown as a wireless configuration, one or more of these connections may also be wired.

Communications network 110 may represent any communications network used to communicate with other entities, including the Internet, an intranet, a radio network, a wireless network, etc. The one or more data sources 130 may include one or more databases that contain information for weather information, airport information, aircraft information, NOTAMs, PIREPs, METARs, aircraft performance data, pilot certifications, weight and balance information, etc. The data sources 130 may also be the receiving and forwarding hub for real-time or near-real time information, such as flight plan status information, current weather conditions, etc.

Users 140 may represent one or more pilots, air crewmen, company administrative personnel, etc. that require a flight risk assessment from the smart safety management unit 120. The smart safety management unit 120 may be any server, computer, processing device, personal digital assistant (PDA), or other similar device capable of storing and managing information from data sources 130, and calculating risk factor values needed to complete risk assessment forms.

The smart safety management unit 120 may calculate risk factor values after receiving, storing and considering information from data sources 130, including Meteorological Terminal Aviation Routine Weather Reports (METARs), Terminal Area Forecast reports (TAFs), Notice to Airmen reports (NOTAMs), Pilot Reports (PIREPs), runway information at departure, destination and stopover airports, control tower operation information, runway approaches available at destination and stopover airports, geospatial definition of mountainous terrain areas, oceanic areas, and other areas with high risk operation, sunset/sunrise definitions for airports, crosswind component and tailwind component, information, takeoff and landing limit weights, identification of Pilot in Command (PIC) and Second In Command (SIC) individuals and their experience and currency in the aircraft, extracted (FOB) at landing from computed flight plans, Terminal Weather Information for Pilot (TWIP)-capable airport information to assess risk related to convective activity, etc., for example.

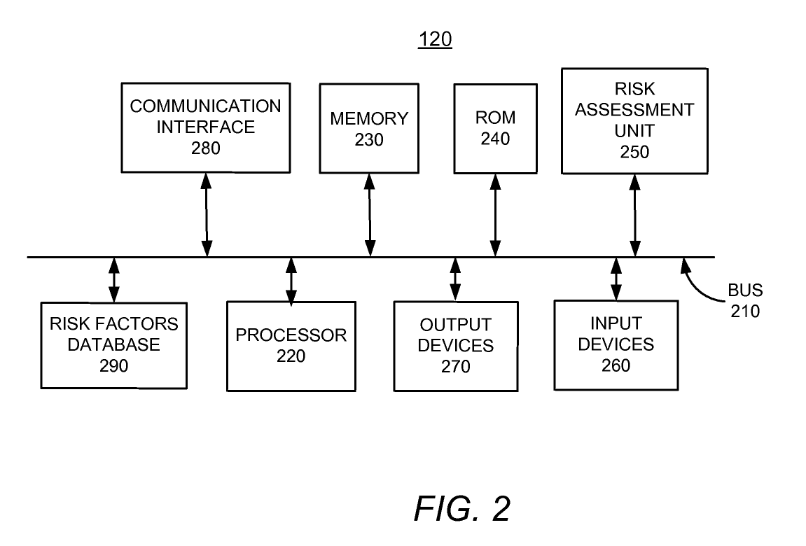

FIG. 2 is a block diagram of an exemplary smart safety management unit 120 in accordance with a possible embodiment of the disclosure. The exemplary smart safety management unit 120 may include a bus 210, a processor 220, a memory 230, a read only memory (ROM) 240, a display bank content management unit 250, input devices 260, output devices 270, a communication interface 280, and a risk factors database 290. Bus 210 may permit communication among the components of the smart safety management unit 120.

Processor 220 may include at least one conventional processor or microprocessor that interprets and executes instructions. Memory 230 may be a random access memory (RAM) or another type of dynamic storage device that stores information and instructions for execution by processor 220. Memory 230 may also store temporary variables or other intermediate information used during execution of instructions by processor 220. ROM 240 may include a conventional ROM device or another type of static storage device that stores static information and instructions for processor 220. Memory 230 may also represent any type of storage media or media drive, such as, for example, magnetic or optical recording media and its corresponding drive.

Input device 260 may include one or more conventional mechanisms that may permit a user to input information to the smart safety management unit 120, such as a keyboard, a mouse, a pen, a voice recognition device, etc. Output device 270 may include one or more conventional mechanisms that output information to the user, including a display, a printer, one or more speakers, or a medium, such as a memory, or a magnetic or optical disk and a corresponding disk drive.

Communication interface 280 may include any transceiver-like mechanism that enables the display bank content management unit 250 to communicate via a network. For example, communication interface 280 may include a modem, or an Ethernet interface for communicating via a local area network (LAN). Alternatively, communication interface 280 may include other mechanisms for communicating with other devices and/or systems via wired, wireless or optical connections.

The risk factor database 290 may include one or more risk factor categories, the risk factor categories being at least one of Trip Type, Airport, Duty Day/Flight Hours, Aircraft Loading, Time of Day, Crew Experience/Currency, Environmental/Weather, External Factors, Terrain, and Runway Conditions. Under these categories, the risk factor database 290 may store information from data sources 130, including Meteorological Terminal Aviation Routine Weather Reports (METARs), Terminal Area Forecast reports (TAFs), Notice to Airmen reports (NOTAMs), Pilot Reports (PIREPs), runway information at departure, destination and stopover airports, control tower operation information, runway approaches available at destination and stopover airports, geospatial definition of mountainous terrain areas, oceanic areas, and other areas with high risk operation, sunset/sunrise definitions for airports, crosswind component and tailwind component, information, takeoff and landing limit weights, identification of Pilot in Command (PIC) and Second In Command (SIC) individuals and their experience and currency in the aircraft, extracted (FOB) at landing from computed flight plans, Terminal Weather Information for Pilot (TWIP)-capable airport information to assess risk related to convective activity, etc., for example

The smart safety management unit 120 may perform such functions in response to processor 220 by executing sequences of instructions contained in a computer-readable medium, such as, for example, memory 230, a magnetic disk, or an optical disk. Such instructions may be read into memory 230 from another computer-readable medium, such as a storage device, or from a separate device via communication interface 280.

The smart safety management unit 120 illustrated in FIGS. 1-2 and the related discussion are intended to provide a brief, general description of a suitable computing environment in which the disclosure may be implemented. Although not required, the disclosure will be described, at least in part, in the general context of computer-executable instructions, such as program modules, being executed by smart safety management unit 120, such as a general purpose computer. Generally, program modules include routine programs, objects, components, data structures, etc. that perform particular tasks or implement particular abstract data types. Moreover, those skilled in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like.

Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

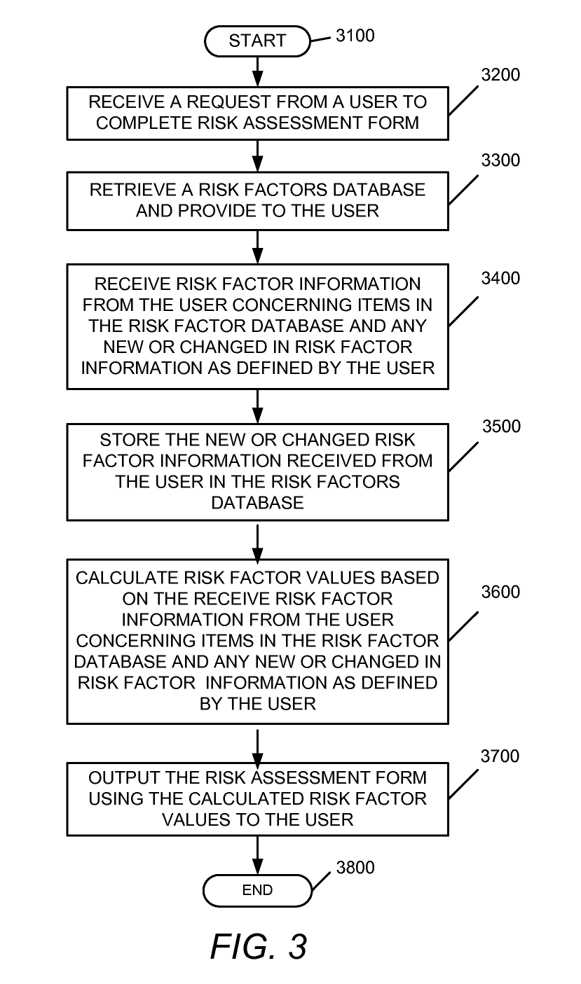

For illustrative purposes, the operation of the smart safety management unit 120 and the risk assessment management unit 250 process will be described below in FIG. 3 in relation to the diagrams shown in FIGS. 1-2.

FIG. 3 is an exemplary flowchart of a smart safety management process in accordance with one possible embodiment of the disclosure. The process begins at step 3100 and continues to step 3200 where the risk factor assessment unit 250 may receive a request from a user to complete risk assessment form through the communication interface 280. The risk assessment form may be a matter of a few questions or a matter of a few or several pages long.

At step 3300, the risk factor assessment unit 250 may retrieve the risk factors database from the memory 230 and may provide the risk factors database 290 to the user. At step 3400, the risk factor assessment unit 250 may receive risk factor information from the user concerning items in the risk factor database 290 and any new or changed risk factor information as defined by the user through the communication interface 280. The user may have to answer all of the risk factors in the risk assessment in some manner or may only answer the risk factors in which the user is interested.

At step 3500, the risk factor assessment unit 250 may store the new or changed risk factor information received from the user in the risk factors database 290. At step 3600, the risk factor assessment unit 250 may calculate risk factor values based on the received risk factor information from the user concerning items in the risk factor database 290 and any new or changed in risk factor information as defined by the user. The risk factor values may be in a range (e.g., 1-5 with 5 being the highest risk), or may be a Go (i.e., the pilot and crew are recommended to proceed with the flight) or No-Go (i.e., a recommendation that the flight be canceled) threshold for each risk factor. The final assessment may be a composite value in a range where any composite value over a certain number suggests a No-Go decision for the flight.

At step 3700, the risk factor assessment unit 250 may output the risk assessment form containing the calculated risk factor values and may provide the form to the user. The risk assessment unit 250 may output the risk assessment form as at least one of an online form, a paper form, and an internet-based web page. The risk assessment unit 250 may email, fax, on-line submit, etc. to the user or other authority. The process may then go to step 3800 and end.

The user may be able to modify the calculated risk factor values and the risk assessment form may be regenerated. The risk assessment unit 250 may store the risk assessment forms of multiple users in the memory 230, and analyzes the stored risk assessment forms for trends. The analysis may consider user inputs to various risk factors, user modifications to various risk factors, flight parameters, airport and weather conditions related to various risk factors, etc. Trending may then be performed based on the analysis. These trends may assist in defining and/or refining risk factors and risk factor values.

The risk assessment unit 250 may receive updated flight plan information from the user, re-calculate risk factor values based on the updated flight plan information, and output an updated risk assessment form containing the re-calculated risk factor values and provides the updated form to the user. The updated flight plan information may be the result of change in destination, aircraft, route of flight, stopover airports, NOTAMs, PIREPs, weather reports, fuel load, change in pilot or crew, change in the weight and balance information, etc.

Embodiments within the scope of the present disclosed embodiments may also include computer-readable media for carrying or having computer-executable instructions or data structures stored thereon. Such computer-readable media may be any available media that may be accessed by a general purpose or special purpose computer. By way of example, and not limitation, such computer-readable media may comprise RAM, ROM, EEPROM, CD-ROM or other optical disk storage, magnetic disk storage or other magnetic storage devices, or any other medium which may be used to carry or store desired program code means in the form of computer-executable instructions or data structures. When information may be transferred or provided over a network or another communications connection (either hardwired, wireless, or combination thereof) to a computer, the computer properly views the connection as a computer-readable medium. Thus, any such connection may be properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that may be executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the disclosed embodiments may be part of the scope of the disclosed embodiments. For example, the principles of the disclosed embodiments may be applied to each individual user where each user may individually deploy such a system. This be enables each user to utilize the benefits of the disclosed embodiments even if any one of the large number of possible applications do not need the functionality described herein. In other words, there may be multiple instances of the disclosed system each processing the content in various possible ways. It does not necessarily need to be one system used by all end users. Accordingly, the appended claims and their legal equivalents should only define the disclosed embodiments, rather than any specific examples given.

What is claimed is:

1. A method for smart safety management, comprising:
receiving a request from a user to complete risk assessment form;
retrieving a risk factors database from a memory and providing the risk factors database to the user;
receiving risk factor information from the user concerning items in the risk factor database and any new or changed in risk factor information as defined by the user;
storing the new or changed risk factor information received from the user in the risk factors database;
calculating risk factor values based on the received risk factor information from the user concerning items in the risk factor database and any new or changed risk factor information as defined by the user; and
outputting the risk assessment form containing the calculated risk factor values and providing the form to the user.

2. The method of claim 1, wherein the user can modify the calculated risk factor values.

3. The method of claim 1, further comprising:
storing the risk assessment forms of multiple users; and
analyzing the stored risk assessment forms for trends.

4. The method of claim 1, wherein the risk factor values are calculated after considering at least one of Meteorological Terminal Aviation Routine Weather Reports (METARs), Terminal Area Forecast reports (TAFs), Notice to Airmen reports (NOTAMs), Pilot Reports (PIREPS), runway information at departure, destination and stopover airports, control tower operation information, runway approaches available at destination and stopover airports, geospatial definition of mountainous terrain areas, oceanic areas, and other areas with high risk operation, sunset/sunrise definitions for airports, crosswind component and tailwind component, information, takeoff and landing limit weights, identification of Pilot in Command (PIC) and Second In Command (SIC) individuals and their experience and currency in the aircraft, extracted Fuel on Board (FOB) at landing from computed flight plans, and Terminal Weather Information for Pilot (TWIP)-capable airport information to assess risk related to convective activity.

5. The method of claim 1, further comprising:
receiving updated flight plan information from the user; and
re-calculating risk factor values based on the updated flight plan information; and
outputting an updated risk assessment form containing the re-calculated risk factor values and providing the updated form to the user.

6. The method of claim 1, wherein the risk factor database includes one or more risk factor categories, the risk factor categories being at least one of Trip Type, Airport, Duty Day/Flight Hours, Aircraft Loading, Time of Day, Crew Experience/Currency, Environmental/Weather, External Factors, Terrain, and Runway Conditions.

7. The method of claim 1, wherein the risk assessment form is output as at least one of an online form, a paper form, and an internet-based web page.

8. A smart safety management unit, comprising:
a communication interface;
a memory;
a risk factor database stored in the memory; and
a risk assessment unit that receives a request from a user to complete risk assessment form through the communication interface, retrieves the risk factors database from the memory and provides the risk factors database to the user, receives risk factor information from the user concerning items in the risk factor database and any new or changed risk factor information as defined by the user through the communication interface, stores the new or changed risk factor information received from the user in the risk factors database, calculates risk factor values based on the received risk factor information from the user concerning items in the risk factor database and any new or changed in risk factor information as defined by the user, and outputs the risk assessment form containing the calculated risk factor values and provide the form to the user.

9. The smart safety management unit of claim 8, wherein the user can modify the calculated risk factor values.

10. The smart safety management unit of claim 8, wherein the risk assessment unit stores the risk assessment forms of multiple users in the memory, and analyzes the stored risk assessment forms for trends.

11. The smart safety management unit of claim 8, wherein the risk factor values are calculated after considering at least one of Meteorological Terminal Aviation Routine Weather Reports (METARs), Terminal Area Forecast reports (TAFs), Notice to Airmen reports (NOTAMs), Pilot Reports (PIREPS), runway information at departure, destination and stopover airports, control tower operation information, runway approaches available at destination and stopover airports, geospatial definition of mountainous terrain areas, oceanic areas, and other areas with high risk operation, sunset/sunrise definitions for airports, crosswind component and tailwind component, information, takeoff and landing limit weights, identification of Pilot in Command (PIC) and Second In Command (SIC) individuals and their experience and currency in the aircraft, extracted Fuel on Board (FOB) at landing from computed flight plans, and Terminal Weather Information for Pilot (TWIP)-capable airport information to assess risk related to convective activity.

12. The smart safety management unit of claim 8, wherein the risk assessment unit receives updated flight plan information from the user, re-calculates risk factor values based on the updated flight plan information, and outputs an updated risk assessment form containing the re-calculated risk factor values and provides the updated form to the user.

13. The smart safety management unit of claim 8, wherein the risk factor database includes one or more risk factor categories, the risk factor categories being at least one of Trip Type, Airport, Duty Day/Flight Hours, Aircraft Loading, Time of Day, Crew Experience/Currency, Environmental/Weather, External Factors, Terrain, and Runway Conditions.

14. The smart safety management unit of claim 8, wherein the risk assessment unit outputs the risk assessment form as at least one of an online form, a paper form, and an internet-based web page.

15. A non-transitory computer-readable medium storing instructions for controlling a computing device for smart safety management, the instructions comprising:
receiving a request from a user to complete risk assessment form;
retrieving a risk factors database from a memory and providing the risk factors database to the user;
receiving risk factor information from the user concerning items in the risk factor database and any new or changed risk factor information as defined by the user;
storing the new or changed risk factor information received from the user in the risk factors database;
calculating risk factor values based on the received risk factor information from the user concerning items in the risk factor database and any new or changed in risk factor information as defined by the user; and
outputting the risk assessment form containing the calculated risk factor values and providing the form to the user.

16. The non-transitory computer-readable medium of claim 15, wherein the user can modify the calculated risk factor values.

17. The non-transitory computer-readable medium of claim 15, further comprising:
storing the risk assessment forms of multiple users; and
analyzing the stored risk assessment forms for trends.

18. The non-transitory computer-readable medium of claim 15, wherein the risk factor values are calculated after considering at least one of Meteorological Terminal Aviation Routine Weather Reports (METARs), Terminal Area Forecast reports (TAFs), Notice to Airmen reports (NOTAMs), Pilot Reports (PIREPS), runway information at departure, destination and stopover airports, control tower operation information, runway approaches available at destination and stopover airports, geospatial definition of mountainous terrain areas, oceanic areas, and other areas with high risk operation, sunset/sunrise definitions for airports, crosswind component and tailwind component, information, takeoff and landing limit weights, identification of Pilot in Command (PIC) and Second In Command (SIC) individuals and their experience and currency in the aircraft, extracted Fuel on Board (FOB) at landing from computed flight plans, and Terminal Weather Information for Pilot (TWIP)-capable airport information to assess risk related to convective activity.

19. The non-transitory computer-readable medium of claim 15, further comprising:
receiving updated flight plan information from the user; and
re-calculating risk factor values based on the updated flight plan information; and
outputting an updated risk assessment form containing the re-calculated risk factor values and providing the updated form to the user.

20. The non-transitory computer-readable medium of claim 15, wherein the risk factor database includes one or more risk factor categories, the risk factor categories being at least one of Trip Type, Airport, Duty Day/Flight Hours, Aircraft Loading, Time of Day, Crew Experience/Currency, Environmental/Weather, External Factors, Terrain, and Runway Conditions.

21. The non-transitory computer-readable medium of claim 15, wherein the risk assessment form is output as at least one of an online form, a paper form, and an internet-based web page.
